(19) United States
(12) Patent Application Publication
(10) Pub. No.: US 2025/0180145 A1
(43) Pub. Date: Jun. 5, 2025

(54) ROTARY JOINT ASSEMBLY FOR PROVIDING A TIRE INFLATION SYSTEM

(71) Applicant: DANA ITALIA S.R.L., Arco (IT)

(72) Inventors: Andrea BORTOLI, Arco (IT); Marco SCOPESI, Arco (IT); Davide DEIMICHEI, Arco (IT); Gianluca TERRASI, Arco (IT)

(21) Appl. No.: 18/969,043

(22) Filed: Dec. 4, 2024

(30) Foreign Application Priority Data
Dec. 5, 2023 (DE) 20 2023 107 206.2

(51) Int. Cl. F16L 27/08; B60C 23/00

(52) U.S. Cl. CPC F16L 27/0804; B60C 23/00363

(57) ABSTRACT

The present disclosure relates to a rotary joint assembly for providing a tire inflation system in a vehicle, the rotary joint assembly comprising:
at least a first air passage configured to transmit air between a first vehicle component of the vehicle and a second vehicle component of the vehicle, wherein the first vehicle component and the second vehicle component are rotatable relative to one another about a rotation axis,
at least a first air seal for at least partially sealing the first air passage, and
at least a first lubricant seal for sealing the first air seal from a lubricant,
   wherein the first air seal is arranged at a first seal carrier and the first lubricant seal is arranged at a second seal carrier, wherein the first seal carrier and the second seal carrier are non-integrally formed.

### CROSS REFERENCE TO RELATED APPLICATION

This application claims priority to German Utility Model Application No. 20 2023 107 206.2, entitled “ROTARY JOINT ASSEMBLY FOR PROVIDING A TIRE INFLATION SYSTEM”, filed Dec. 5, 2023. The entire contents of the above-identified application is hereby incorporated by reference for all purposes.

### TECHNICAL FIELD

The present disclosure relates to a rotary joint assembly for providing a tire inflation system in a vehicle. The vehicle may be a non-track bound land vehicle, such as a tractor, wheel loader, dumper, wheeled excavator, or the like.

### BACKGROUND AND SUMMARY

Tire inflation systems may be utilized to measure and adjust the pneumatic pressure of a vehicle tire to improve the maneuverability of the vehicle and to reduce fuel consumption when the vehicle drives on different terrain types. For example, the pressure of a vehicle tire may be lowered to provide additional traction for the vehicle when the vehicle travels on soft terrain such as sand or mud. The tire pressure may be raised to reduce the rolling resistance of the vehicle when the vehicle travels on an asphalt road.

Tire inflation systems typically comprise a stationary portion such as a spindle including a first fluid line, a rotatable portion such as a wheel hub including a second fluid line, and a rotary joint including a sealed air passage which provides fluidic communication between the first fluid line and the second fluid line including when the vehicle is moving. Tire inflation systems may also comprise a pressure source providing pressurized air and e.g. being fluidically connected to the first fluid line.

For instance, WO 2013/156430 A1 discloses a spindle assembly for a tire inflation system, wherein a fluid conduit extending through a spindle is in fluidic communication with a fluid passage extending through a rotatable part via an annular seal chamber. Fluid leaked out of the annular seal chamber may be exhausted to the atmosphere via a breather line.

There continues to be demand for a rotary joint assembly which reduces the risk of lubricant or dirt contaminating seals of the rotary joint assembly.

A rotary joint assembly and an assembly which at least partially meet this demand are defined herein, in this description and in the figures.

Accordingly, a rotary joint assembly is suggested for providing a tire inflation system in a vehicle. For example, the rotary joint assembly may be comprised by the tire inflation system or, put differently, may form at least a part of said tire inflation system.

The rotary joint assembly comprises:
at least one air passage configured to transmit air between a first vehicle component of the vehicle and a second vehicle component of the vehicle, wherein the first vehicle component and the second vehicle component are rotatable relative to one another about a rotation axis (e.g. meaning at least one of the first and second vehicle component is rotatable about the rotation axis and thus relative to the respective other one of the first and second vehicle component which might be stationary),
   at least a first air seal for at least partially sealing the air passage,
   at least a first lubricant seal for sealing the air seal from a lubricant,
   wherein the air seal is arranged at a first seal carrier and the first lubricant seal is arranged at a second seal carrier, wherein the first seal carrier and the second seal carrier are non-integrally formed.

In other words, the first seal carrier and second seal carrier are separate components and/or are configured apart from one another. For example, they may be produced, handled and/or mounted individually. This provides a certain modularity which e.g. enables adjusting axial distances between these components depending on a given type of tire inflation system to be produced. Also, this enables combining different types of first and second seal carriers for configuring different rotary joint assemblies depending on a given use case. This increases flexibility compared to known rotary joint assemblies in which a typically bulky cartridge-type component is provided comprising both of the air seals as well as lubricant seals and typically. Such a cartridge-type component has to be specifically developed for each type of tire inflation system and cannot be modularly adjusted to match different types of tire inflation system to be produced.

Further, the present configuration allows for selectively replacing only one of the first and second seal carriers in a case of failure. Also, it enables re-using the first and second seal carriers in other rotary joint assemblies. Further, the number of the first seal carriers can be varied to adjust a number of needed air passages. For example, any region that is axially enclosed between two first seal carriers can be used as a section of a respective air passage.

Compared with existing solutions, the present solution usually further enables omitting at least some seals. This concerns for example seals between the first seal carrier and/or the second seal carrier and the one of the first and second vehicle component relative to which the first and/or second seal carrier is non-rotatable. Rather, the first and second seal carrier may directly provide respective sealing functions with respect to the first and/or second vehicle component relative to which they are non-rotatable, e.g. by way of contacting them. For example, the first and second seal carrier may comprise a resilient material and may for example be coated with a resilient material so that a respective sealing effect can be provided when abutting against the first and/or second vehicle component.

Any of the first seal carrier, second seal carrier, first air seal and first lubricant seal may be ring-shaped members. These may e.g. extent concentrically to the rotation axis and/or about a radially inner one of the first and second eco-component. The first and second seal carrier may comprise a material that is different from a material comprised by the first air seal and first lubricant seal. For example, said material may be harder and/or less elastic than a material of the first air seal and first lubricant seal.

The second seal carrier may be connected and/or secured to a radially outer one of the first and second vehicle component, e.g. by way of a force-fit and/or a form-fit. The first seal carrier may be connected and for example secured to a radially outer one of the first and second vehicle component, e.g. by way of a force-fit and/or a form-fit. This may include and/or correspond to an engagement being formed between these members according to any of the below-discussed embodiments.

The first vehicle component and the second vehicle component may each comprise fluid lines. The first air passage may be fluidically connected to said fluid lines, thereby being able to transmit air between the first and second vehicle components. For example, the air passage may lead to and/or end opposite to any of said fluid lines.

The first air passage may at least in part be delimited by the first air seal and/or the first lubricant seal. Additionally or alternatively, it may at least in part be delimited by the first seal carrier and/or the second seal carrier. The first air passage (or any of the further passages discussed herein) may comprise or be delimited by an open space between members of the rotary joint assembly. The first air passage may fully or at least in sections extend radially. In other words, it may be configured to guide air radially between the first and second vehicle component.

One of the first and second vehicle component may be stationary. The other one may be rotatable. The first vehicle component and the second vehicle component may at least partially be received in one another. At least a section of the first vehicle component may be located radially inwards of the second vehicle component. The rotary joint assembly and for example the first and second seal carrier as well as an optional bushing discussed below may at least partially be positioned radially between the first and second vehicle component. The first and second seal carrier may each be secured at one of the first and second vehicle component, so that the respective other one of the first and second vehicle component may rotate relative to said seal carriers.

The first vehicle component may e.g. be a stationary, spindle or axle housing. It may comprise a first fluid line in fluidic communication with the first air passage. The second vehicle component may be a wheel or a wheel hub. The second vehicle component may comprise a second fluid line in fluidic communication with the first air passage.

The rotation axis of the rotatable component, for example of the second vehicle component, may define an axial direction. Radial directions may extend perpendicular to this axial direction.

Typically, the first air passage is configured to provide fluidic communication between the first fluid line and the second fluid line. For example, the first fluid line may be fluidically connected or fluidically connectable to a pressure source such as a compressor, and/or to the atmosphere. The second fluid line may be fluidically connected or fluidically connectable to a pneumatic tire mounted on or configured to be mounted on the second vehicle component. The pneumatic tire may be inflated and/or deflated via the first fluid line, the first air passage and the second fluid line.

The rotary joint assembly may also comprise a second lubricant seal, wherein the first air seal is axially positioned between the first and second lubricant seals. This way, the air seal may be protected from lubricant from both axial sides.

In this context, the second lubricant seal may be arranged at a third seal carrier that is non-integrally formed with the first and second seal carrier. The first seal carrier may be axially positioned between the second and third seal carrier.

The rotary joint assembly may also comprise a second air seal that is arranged at the first seal carrier, wherein the first and second air seal and are axially spaced apart from one another.

According to one embodiment, the first air passage is located axially between the first air seal and the first lubricant seal. A second air passage may be located axially between the first air passage and/or an optional second air passage and a second lubricant seal.

In one embodiment, the first air passage extends outside of the first seal carrier.

In another embodiment, the first air passage extends through the first seal carrier. In case of a plurality of air passages being provided, these may each be configured according to any of the embodiments disclosed herein. Accordingly, any combination of air passages according to any of the disclosed embodiments may be formed. For example, a first air passage may extend outside of the first seal carrier and e.g. between the first air seal and first lubricant seal. A second air passage may extend through the first seal carrier.

According to a further embodiment, the rotary joint assembly further comprises a bushing that is arranged radially opposite to the first seal carrier and/or to the second seal carrier. The bushing may be a cylindrical member and/or sleeve-like member. It may extend along and/or concentric to the rotation axis. The bushing may be made of a metal such as steel. However, it is understood that the bushing may be made of or may include other materials, e.g. plastic materials. The bushing—and for example a radially inner circumferential surface thereof—may contact a radially outer circumferential surface of the first vehicle component or generally of the radially inner one of the first and second vehicle component. A radially outer circumferential surface of the bushing may face any and for example all of the first air seal, first lubricant seal, first seal carrier and second seal carrier.

According to one embodiment, the bushing is in contact with the first air seal and/or the first lubricant seal. This contact may include a sliding sealing engagement of the first air seal and/or the first lubricant seal and the bushing. However, it is understood that in embodiments which do not include a bushing the first air seal and/or the first lubricant seal may be in sliding sealing engagement with one of the first and second vehicle component and for example a stationary one thereof. Alternatively, the first air seal and/or the first lubricant seal may be in sliding sealing engagement with a rotatable one of the first and second vehicle component.

Generally, the bushing may comprise surfaces that enable contact conditions e.g. to one of the first and second vehicle component and/or to the first air seal and first lubricant seal. The bushing provides a cost reduction potential compared to machining e.g. the first vehicle component so as to enable similar contact conditions.

The rotary joint assembly may comprise at least one sealing member that is disposed on a side of the bushing facing away from the first air seal and/or the first lubricant seal. This side may be a radially inner side and for example a radially inner circumferential surface of the bushing. It may face and/or contact the radially inner one of the first and second the vehicle component. The sealing member may help to prevent that lubricant enters a section of the first passage (or any other passage) which in some embodiments may extend through the bushing.

For example, the at least one sealing member may comprise a sealing ring received in an indentation or, in other words, a recess formed in the bushing or in the radially inner one of the first and second vehicle component. This may simplify mounting the bushing onto the respective one of the first and second vehicle component. For example, the typically elastically deformable sealing ring may be compressed into said indentation or recess when pushing the bushing onto the respective one of the first and second vehicle component.

According to one example, the first air passage extends through the bushing. This may enable a radially straight course of the first air passage which may simplify the overall design of the rotary joint assembly.

The rotary joint assembly and/or the assembly discussed below may include a first bearing and a second bearing such as for rotatably mounting the first and second vehicle component. For example, the first bearing and a second bearing may rotably support the first and second vehicle components relative to one another. The first bearing and the second bearing may be rotation bearings and for example rolling bearings. The bushing may be disposed axially between the first bearing and the second bearing. For example, the bushing may be disposed axially between an inner ring and/or an outer ring of the first bearing and an inner ring and/or an outer ring of the second bearing.

In one embodiment, the first seal carrier is configured to form an engagement with one of the first and second vehicle component, and for example with the radially outer one of the first and second vehicle component, to secure an axial position of the first seal carrier. The engagement may correspond to or comprise a form-fit between these members. It may provide a particularly compact way of axially securing the first seal carrier, while at the same time simplifying mounting it in the rotary joint assembly. For example, an axial push operation may suffice to bring the first seal carrier and the first or second vehicle component into the engagement with one another.

In one embodiment, the first seal carrier comprises a circlip or another elastically deformable member to form the engagement, where in the other elastically deformable member is for example ring-shaped. For example, the circlip or the other elastically deformable member may be held in a recess in the first seal carrier. The circlip or other elastically deformable member may be temporarily compressed to an increased extent into said recess when mounting and in a particular axially inserting the first seal carrier e.g. into the first or second vehicle component. The circlip or other elastically deformable member may be arrangeable opposite to a recess in the first or second vehicle component. It may radially expand into said recess to form the engagement.

Alternatively, the first seal carrier may comprise a receiving section, for example a recess, in which the circlip or the other elastically deformable member held at the respective one of the first and second vehicle component may be received to form the engagement. Accordingly, in one embodiment the circlip or other elastically deformable member is radially compressible.

Another way of forming the engagement, which also may be provided in addition to any of the above embodiments concerning the engagement, includes the following: A recess is formed in the first seal carrier or in the respective one of the first and second vehicle component. A protrusion is formed at the respective other one of the first seal carrier and the respective one of the first and second vehicle component. The recess and protrusion are configured to form the engagement, e.g. by being received in one another and/or being locked with one another.

In one embodiment, the first seal carrier is configured to from an engagement in two different regions (i.e. is configured to form two distinct engagements), wherein the first air passage is located axially between the different regions. Put differently, two engagements may be formed in different locations, said locations being axially apart and e.g. being comprised by the different regions.

According to a further embodiment, a second air passage is provided, wherein the first air passage and the second air passage are configured to be operated at different air pressures, for example wherein the first and second air passages are configured to be fluidically connected to different pressurized air sources of the vehicle or to different tires of the vehicle. For example, the first and second air passages may be separately provided and/or not be fluidically connected to one another. They may further comprise individual connecting portions, e.g. ports, to provide the fluidic connections to the different tires and/or pressurized air sources.

Additionally or alternatively, one of the two air passages (or any single air passage) might be a pilot channel to pneumatically control a wheel valve, for instance. As detailed below, the present disclosure generally allows for modularly increasing the number of separate air passages, for example by way of adding further first seal carriers, e.g. in axial succession to one another.

The disclosure also concerns an assembly for providing a tire inflation system in a vehicle, the assembly comprising:
a rotary joint assembly according to any of the previous claims;
the first and second vehicle component.

The assembly may comprise any further components discussed herein and interacting with the rotary joint assembly to provide a tire inflation function. For example, the assembly may further comprise the first and second bearing discussed herein and/or a source of pressurized air.

Embodiments of the disclosure are discussed in the following with respect to the schematic figures. Throughout the figures, same or comparable features may be marked with same reference signs.

### BRIEF DESCRIPTION OF THE FIGURES

FIG. 1 shows a rotary joint assembly according to a first embodiment.

FIG. 2 shows a rotary joint assembly according to a second embodiment.

FIG. 3 shows an enlarged detail view of the second embodiment.

FIG. 4 shows a rotary joint assembly according to a third embodiment.

FIG. 5 shows a rotary joint assembly according to a fourth embodiment.

### DETAILED DESCRIPTION

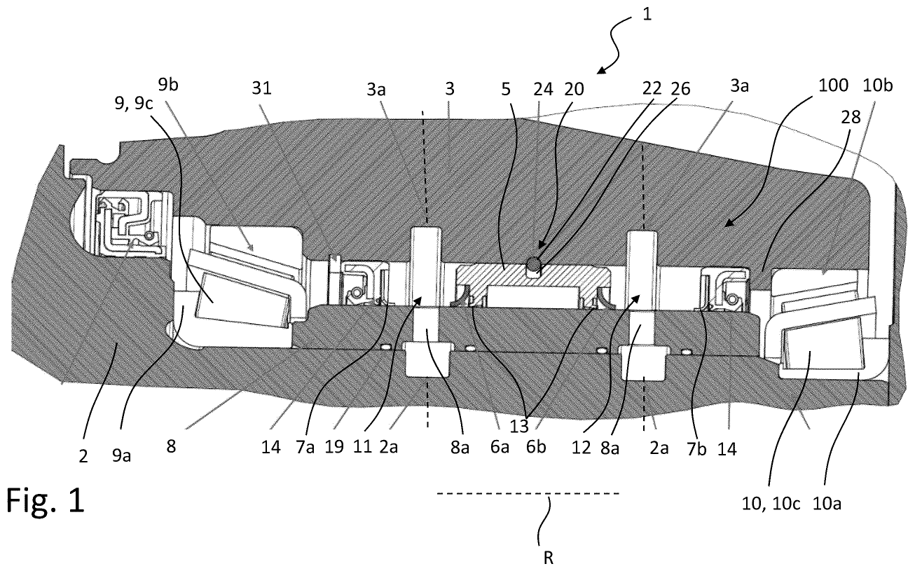

FIG. 1 illustrates a rotary joint assembly 100 for configuring a tire inflation system of an automotive vehicle according to a first embodiment. Also shown is an assembly 1 according to a first embodiment which comprises, amongst others, the rotary joint assembly 100.

A first vehicle component 2, such as a spindle or an axle housing, as provided and forms a stationary portion. A second vehicle component 3, such as a wheel or wheel hub, as provided and forms a rotatable portion. In the embodiment of FIG. 1, the second vehicle component 3 is rotatably mounted on the first vehicle component 2 by means of axially spaced roller bearings 9, 10 forming first and second bearings discussed above. The roller bearings 9, 10 each include an inner ring 9a, 10a mounted on the first vehicle component 2, an outer ring 9b, 10b mounted on or attached to the second vehicle component 3, and a plurality of rollers 9c, 10c disposed between the inner ring 9a, 10a and the outer ring 9b, 10b, respectively. As an optional feature, a so-called wheel hub cassette seal 17 is also arranged radially between the first and second vehicle components 2, 3.

A rotation axis R of the second vehicle component 3 is schematically illustrated in FIG. 1 and is arranged below the bearings 9, 10. An axial direction extends along the rotation axis R. A radial direction extends perpendicular to the axial direction. In the embodiment of FIG. 1, the second vehicle component 3 encloses or surrounds the first vehicle component 2 in the radial direction. In other words, the first vehicle component 2 is a radially inner component, whereas the second vehicle component 3 is a radially outer component. However, it is understood that in other embodiments not explicitly depicted here the first vehicle component 2 may enclose or surround the second vehicle component 3 in the radial direction.

The first vehicle component 2 includes a two first fluid lines 2a, and the second vehicle component 3 includes two second fluid lines 3a. The first and second fluid lines 2a, 3a comprise circumferentially extending chamber sections at their radial outer ends and radial inner ends, respectively. Dotted lines schematically indicate that the first and second fluid lines 2a, 3a are not limited to these chamber sections, but may further extend towards other components, such as a non-illustrated air pressure reservoir and/or a tire. For example, the dotted lines may include elongated channel-like the fluidically connecting the annular chamber sections to said other components.

Specifically, the first fluid lines 2a may be in fluidic communication or in selective fluidic communication with a pressure source such as a compressor. Additionally or alternatively, the first fluid lines 2a may be in fluidic communication or in selective fluidic communication with a low pressure tank or with the atmosphere. By contrast, the second fluid lines 3a may be in fluidic communication or in selective fluidic communication with a pneumatic tire which may be mounted on the second vehicle component 3. In this way, a pneumatic tire mounted on the second vehicle component 3 may be inflated and/or deflated via the first fluid lines 2a and the second fluid lines 3a.

The first fluid lines 2a or a portion thereof may be integrally formed with the first vehicle component 2. For example, the first fluid lines 2a may extend into or from a boring in the stationary portion of a circumferentially extending notch which may e.g. form the above-mentioned chamber section. Similarly, the second fluid lines 3a or a portion thereof may be integrally formed with the second vehicle component 3. For example, the second fluid lines 3a may extend into or from a circumferentially extending notch which may e.g. form the above-mentioned chamber section and/or may extend into or from a boring in the second vehicle component 3. The first fluid lines 2a and the second fluid lines 3a are in fluidic communication with one another via first and second passages 11, 12 discussed in further detail below.

The rotary joint assembly 100 also includes an optional sleeve-like bushing 8. Here, the bushing 8 is mounted on the first vehicle component 2. More specifically, the sleeve-like bushing 8 is disposed on a radially outer circumference of the first vehicle component 2. Or in other words, in the radial direction the bushing 8 is disposed between the first vehicle component 2 and the second vehicle component 3. However, it is understood that some embodiments may not include a bushing 8.

In the embodiment depicted here, the radially outer circumference of the first vehicle component 2 and a radially inner surface of the bushing 8 each have a cylindrical shape or an essentially cylindrical shape. The radially inner surface of the bushing 8 faces the rotation axis R of the second vehicle component 3, i. e. faces toward the bottom in FIG. 1. An inner diameter of the bushing 8 may be equal to or just slightly larger than an outer diameter of the first vehicle component 2. For example, the bushing 8 may be fixedly mounted on the stationary portion 2. The bushing 8 may be made of a metal such as steel. However, it is understood that the bushing 8 may be made of or may include other materials.

In the embodiment depicted in FIG. 1, the bushing 8 is—at least during assembly—axially positioned on the stationary portion (i. e. the second vehicle component 2) by the inner ring 9a of the first bearing 9 and by the second bearing 10, e.g. by a cage and/or the outer ring 10b of the second bearing 10. The axial position can be secured in that the bushing 8 is press-fitted on to second vehicle component 2. Generally, the bushing 8 is axially positioned between the first and second bearing 9, 10. The bushing 8 has recesses at a radially inner circumferential surface thereof, wherein sealing members 19 formed as resilient sealing rings are received in said recesses. These sealing members 19 contact an outer circumferential surface of the first vehicle component 2 and act as lubricant seals. Only one of the in total four sealing members 19 shown in FIG. 1 is marked with a respective reference sign.

The bushing 8 includes radially extending borings 8a each forming a section of first and second air passages 11 and 12 of the rotary joint assembly 100. Each boring 8a provides a fluidic communication between one of the first fluid lines 2a of the first vehicle component 2 and one of the second fluid lines 3a of the rotatable portion 3.

Further, the rotary joint assembly 100 includes a sealing assembly comprising a number of air seals 6a, 6b and lubricant seals 7a, 7b. The sealing assembly is disposed radially between the first vehicle component 2 and the second vehicle component 3. More specifically, in the embodiment depicted in FIG. 1 the sealing assembly is disposed radially between the bushing 8 and the second vehicle component 3. The sealing assembly seals the air passages 11, 12 which fluidically connect the first fluid lines 2a with the second fluid lines 3a, respectively.

In the embodiment of FIG. 1, the sealing assembly includes a first air seal 6a sealing a first air passage 11, and a first lubricant seal 7a sealing or protecting the first air seal 6a from lubricant used to lubricate the bearings 9, 10. The sealing assembly also includes second air seal 6b sealing a second air passage 12, and a first lubricant seal 7b sealing or protecting the second air seal 6b from lubricant used to lubricate the bearings 9, 10.

Here, the air passages 11, 12 extend in the radial direction. Along the axial direction the air passages 11 are axially disposed between the roller bearings 9, 10 and between a pair of axially adjacent air seals 6a, 6b and lubricant seals 7a, 7b.

The air seals 6a, 6b are axially spaced and comprise annular sealing lips to which the references sings 6a, 6b point in FIG. 1. The sealing lips may be made of or may comprise a plastic material such as PTFE, for example. Additionally or alternatively, the air seals 6a, 6b may comprise sealing structures 13 as depicted in FIG. 1. These may provide a stronger sealing effect compared to the annular sealing lips. The annular sealing lips may for example act as throttles to protect the sealing structures 13 from excessive exposure to air pressure and/or from excessive air pressure variations. The sealing structures 13 may be made from the same or from a different material compared to the annular sealing lips and for example from a stiffer material. Each sealing structure 13 may form a further sealing lip. Accordingly, each pair of axially adjacent annular sealing lips and sealing structures 13 may form a double sealing lip for defining a respective air seal 6a, 6b.

The air seals 6a, 6b are in sliding sealing engagement with the radially outer surface of the bushing 8. It is understood that in embodiments that do not include a bushing 8, the air seals 6a, 6b may be in sliding sealing engagement with the first vehicle component 2 or possibly with the second vehicle component 3. In the embodiment depicted in FIG. 1, the air seals 6a, 6b and for example their annular sealing lips and/or sealing structures 13 have a convex shape so that a high pressure in the air passages 11, 12 presses the air seals 6a, 6b into sealing engagement or further into sealing engagement with the outer surface of the bushing 8. The air seals 6a, 6b may extend around the entire circumference of the radially outer surface of the bushing 8. Or in other words, the air seals 6a, 6b may have an annular shape and extend around the entire circumference of the radially outer surface of the bushing 8.

A lubricant seal assembly of the rotary joint assembly 100 includes lubricant seals 7a, 7b comprising annular sealing lips. Similar to the sealing structures 13, the lubricant seals 7a, 7b may comprise non-specifically marked further sealing structures to form a double lip seal. Again, the visible annular sealing lips of the lubricant seals 7a, 7b in FIG. 1 may act as throttles for said further sealing structures.

The lubricant seals 7a, 7b protect the air seals 6a, 6b and the air passages 11, 12 from lubricant which is used to lubricate the bearings 9, 10, respectively. The lubricant seals 7a, 7b may be made of or may comprise a plastic material, for example. In the embodiment depicted in FIG. 1, the lubricant seals 7a, 7b are in sliding sealing engagement with the radially outer surface of the bushing 8. It is understood that in embodiments that do not include a bushing 8, the lubricant seals 7a, 7b may be in sliding sealing engagement with the first vehicle component 2 or possibly with the second vehicle component 3.

The lubricant seal 7a is disposed axially between the bearing 9 and the air seal 6a. For example, the lubricant seal 7a is axially spaced from the bearing 9 and from the air seal 6a. Similarly, the lubricant seal 7b is disposed axially between the bearing 10 and the air seal 6b. For example, the lubricant seal 7b is axially spaced from the bearing 10 and from the air seal 6b.

In the embodiment of FIG. 1, each of the air seals 6a, 6b and the lubricant seals 7a, 7b are stationary with respect to the first vehicle component 3. They jointly rotate therewith relative to the bushing 8 and the first vehicle component 2. More specifically, a first ring-shaped seal carrier 5 is fixed to the first vehicle component 3, and the air seals 6a, 6b are attached to the first seal carrier 5.

For example, the first seal carrier 5 may be press-fit to the second vehicle component 3. Additionally or alternatively, FIG. 1 shows an optional engagement 20, or in other words a form-fit, that is formed between first seal carrier 5 and the second vehicle component 3. This engagement 20 is formed between a circlip 22 that is e.g. made from a metallic material and a recess 24 at a radial inner side of the second vehicle component 3. The circlip 22 may be a ring-shaped member, wherein the ring shape is not fully closed. The recess 24 is filled by the circlip 22 in FIG. 1. The first seal carrier 5 and specifically a radially outer circumferential surface thereof facing the second vehicle component 3 also comprises a recess 26. The circlip 22 is at least partially received in said recess 26. The recess 26 provides an unoccupied space into which the circlip 22 can at least temporarily be pressed to an increased extent when mounting the seal carrier 5, which may e.g. include axially pushing the seal carrier 5 along the first vehicle component 3.

The first seal carrier 5 is disposed radially between the first vehicle component 2 and the second vehicle component 3, more specifically between the bushing 8 and the second vehicle component 3. The air seals 6a, 6b are mounted on a radially inner side of the first seal carrier 5. The radially inner side of the first seal carrier 5 faces the rotation axis R of the second vehicle component 3. In the embodiment of FIG. 1, the air passages 11, 12 extend outside of the first seal carrier 5, so that the latter does not provide any fluidic communication within the rotary joint assembly 100.

The lubricant seals 7a, 7b are each attached to one of a second and third seal carrier 14, respectively. The lubricant seals 7a, 7b and/or the second and third seal carrier 14 may generally be identical, but may e.g. be arranged in mirrored fashion relative to one another. The second and third seal carrier 14 may e.g. be press-fit to the second vehicle component 3. The axial positions may be secured by an optional shoulder 28 of the second vehicle component and/or by an optional retaining ring 31.

The lubricant seals 7a, 7b may be made from a material similar to the air seals 6a, 6b. For example, the may also be convexly shaped towards a respectively adjacent air passage 11, 12. The second and third seal carriers 14 may be made from same or a different material compared to the lubricant seals 7a, 7b and to the first seal carrier 5.

As evident from FIG. 1, the first seal carrier 5 as well as the second and third seal carriers 14 are separate members. They are non-integrally formed and are e.g. individually mountable and/or can be individually handled during assembly. This provides a certain level of modularity of the rotary joint assembly 100 for example in that different combinations may be formed of different first seal carriers 5 and second and third seal carriers 14, e.g. depending on a given set of first and second vehicle components 2, 3. Also, this allows for selectively replacing only one of the seal carriers 5, 14 in case of failure and/or re-using the seal carriers 5, 14 in other rotary joint assemblies 100.

Also, contrary to existing solutions, no specific seals are needed between the first and second seal carriers 5, 14 and the second vehicle component 3 relative to which they are non-rotatable. That is, the radially outer circumferential surfaces of the first and second seal carriers 5, 14 which contact a radially inner circumferential surface of the second vehicle component 3 is free of dedicated sealing elements, e.g. comprising sealing lips. Rather, a sufficient sealing effect may directly result from the contact between the first and second seal carriers 5, 14 and the second vehicle component 3. For doing so, the first and second seal carriers 5, 14 may be resilient, e.g. due to comprising a resilient coating.

A non-illustrated pneumatic tire mounted on the second vehicle component 3 may be inflated by pumping compressed air through the first fluid lines 2a, the borings 8a as well as the further sections of the air passages 11, 12 extending between an adjacent pair of air seals 6a, 6b and lubricant seals 7a, 7b. This air may flow towards the tire through the second fluid lines 3a. Accordingly, the air passages 11, 12 are structurally and fluidically separated from one another. They can be used to carry different pressures to fulfill respectively associated individual functions. As discussed herein, such a function may also be a valve control function when acting as a so-called pneumatic pilot line.

Further, it must be stressed that the embodiment of FIG. 1 could be expanded to include even more air passages, e.g. a third air passage in addition to the first and second air passages 11, 12. For doing so, further first seal carriers 5 could be provided and could be axially spaced apart from the already present first seal carrier 5. These further first seal carriers 5 may be placed axially between the second and third seal carriers 14 to ensure a sealing from lubricant. Any region that is axially arranged between two first seal carriers 5 can be used to fluidically connect additional first and second fluid lines 2a, 3a in the first and second vehicle component 2, 3. It is noted that any further air passages may again carry an individual air pressure, independently of any other air passages. This way, the overall assembly can provide more individually settable pneumatic functions.

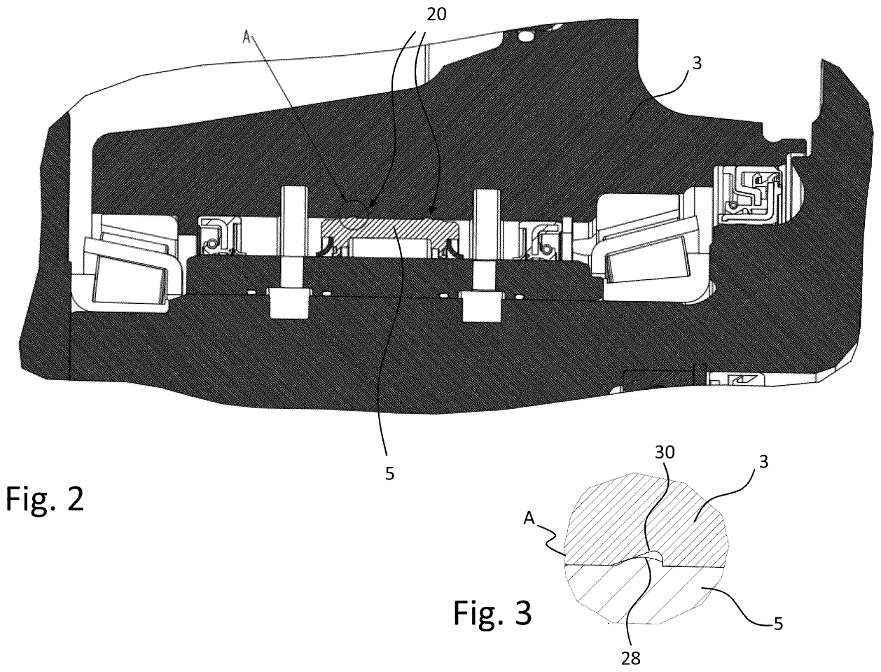

FIG. 2 shows a further embodiment which is largely similar to the embodiment of FIG. 1. Therefore, only a main difference to the embodiment of FIG. 1 will be explained in the following. This difference concerns the engagement 20 that is formed between the first seal carrier 5 and the second vehicle component 3. Specifically, two such engagements 20 are formed and are axially spaced from one another. One of the engagements 20 is shown in an enlarged detail view in FIG. 3, wherein the depicted region A is encircled in FIG. 2.

Forming two such engagements 20 enables arranging said engagements to reliably sustain axial loads due to air pressure and for example air pressure differences. For example, the two air passages 11, 12 might not be pressurized at the same time.

Further, in the embodiment depicted in the figures at least one of the recess 30 and protrusion 28 has a sharp edge which is more effective than a sloped surface in retaining the seal axially. By placing booth recesses 30 in a mirrored and/or back to back orientation as in the embodiment depicted in the figures, axial forces can be reliably sustained in both directions.

FIG. 3 shows that a radial protrusion 28 is formed at the radially outer circumferential surface of the first seal carrier 5. This protrusion 28 is at least partially received in a radial recess 30 formed at an inner circumferential surface of the second vehicle component 3. The recess 30 and/or protrusion 28 may extend along the entire circumference of the respective members. The protrusion 28 and recess 30 engage or, put differently, interlock to axially secure the first seal carrier 5. In order to simplify assembly of the first seal carrier 5, the protrusions 28 or the first seal carrier 5 as such may be formed of a resilient material, e.g. a plastic material and/or rubber. Alternatively, the first seal carrier 5 may be coated with a respective resilient material. It is to be understood that a reversed embodiment is also possible in which the first seal carrier 5 comprises the recess 30 and the second vehicle component 3 comprises the radial protrusion 28.

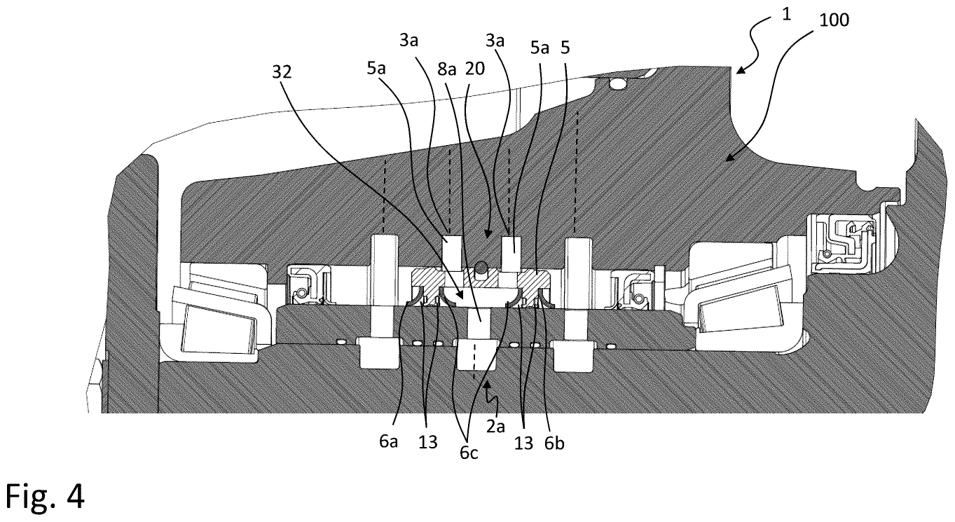

FIG. 4 shows a further embodiment. Again, only main differences compared to the embodiment of FIG. 1 will be discussed. In FIG. 4, a further air passage 32 is provided that extends radially through the first seal carrier 5. This further air passage 32 may be provided in combination with only one of the depicted air passages 11 and 12 or with differently configured air passages are with no additional air passages. The air passage 32 comprises a further boring 8a extending through the bushing 8. This boring 8a is fluidically connected to a further first fluid line 2a in the first vehicle component 2 which is configured similarly to the first fluid lines 2a discussed in connection with FIG. 1.

The further air passage 32 also comprises a section extending between a radially inner side of first seal carrier 5 and a radially outer side of the bushing 8. This section is delimited by further air seals 6c. Specifically, two such further air seals 6c are provided and are axially spaced apart from one another. These further air seals 6c are configured similarly to the air seals 6a, 6b discussed above. Accordingly, they comprise a flexible sealing lip to which the reference sign 6c point. Additionally or alternatively, they comprise additional sealing structures 13 e.g. to define a double sealing lip structure explained above. In the depicted embodiment, each further air seal 6c has a mirrored configuration compared to a respectively adjacent air seal 6a, 6b.

The first seal carrier 5 comprises borings 5a which are each fluidically connected to further second fluid lines 3a in the second vehicle component 3. The further second fluid lines 3a are configured similarly to the ones discussed in connection with FIG. 1. The number of borings 5a and further second fluid lines 3a is only exemplary and only one boring 5a and one further second fluid line 3a may be provided. The borings 5a axially enclose a region between them in which the engagement 20 between the second vehicle component 3 and the first seal carrier 5 is formed.

The further air passage 32 may transmit air at a pressure that is different from the air transmitted by the first and second air passages 11, 12. The further air seals 6c help to fluidically seal the air passages 11, 12, 32 from one another, so as to maintain the pressure differences therebetween. The further air passage 32 may e.g. serve as a pneumatic control line (e.g. a pilot line) to pneumatically operate at least one non-illustrated valve, e.g. in order to control inflation and deflation of the non-illustrated tire.

For the sake of completeness, it is noted that at the circumferential outer surface of the first seal carrier 5 in FIG. 4, protrusion-like structures are shown similar to the protrusions 28 of FIG. 3. This, however is non-limiting and such protrusions may be omitted. In the embodiment depicted in the figures, they are not actually needed because they do not form an engagement with the second vehicle component 3. Yet, such an engagement similar to FIG. 3 could be provided to additionally secure the first seal carrier 5 at the second vehicle component 3.

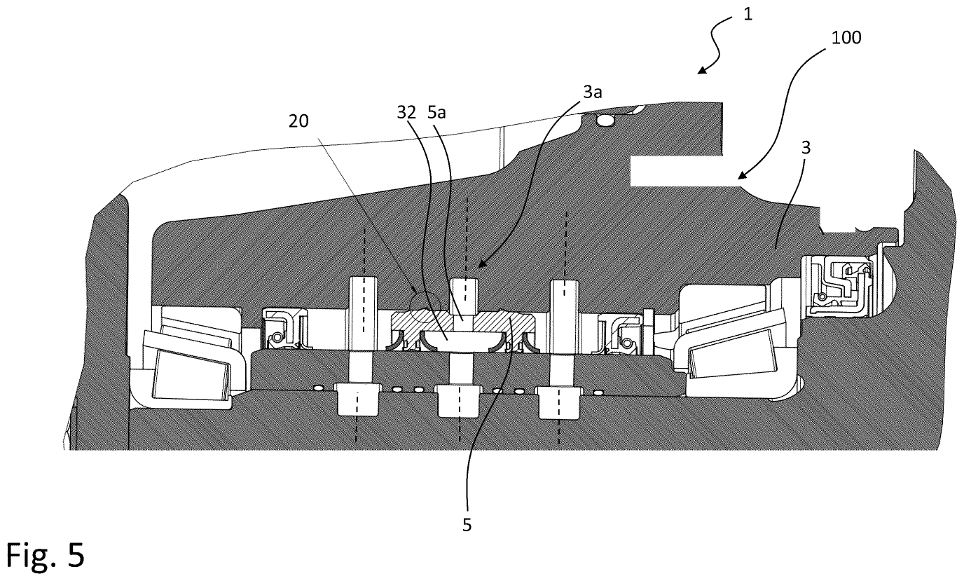

FIG. 5 shows a further embodiment that is similar to the embodiment of FIG. 4 in that an additional air passage 32 through the first seal carrier 5 is provided. Also, the first seal carrier 5 comprises the further air seals 6c discussed in connection with FIG. 4. In this case, however, only one boring 5a is provided in the first seal carrier 5 to connect to only one second fluid line 3a of the second vehicle component 3. This is not mandatory and further borings 5a to connect to further second fluid lines 3a could be present.

A further difference to the embodiment of FIG. 4 concerns the engagement 20 formed between the first seal carrier 5 and the second vehicle component 3. In the embodiment of FIG. 5, two such engagements 20 are formed similar to the embodiment of FIG. 2. Accordingly, these engagements 20 include interlocking a protrusion and recess. In FIG. 5, one of the engagement 20 is encircled and this region is configured similarly to the detailed view of FIG. 3.

1. A rotary joint assembly for providing a tire inflation system in a vehicle, comprising:
at least a first air passage configured to transmit air between a first vehicle component of the vehicle and a second vehicle component of the vehicle, wherein the first vehicle component and the second vehicle component are rotatable relative to one another about a rotation axis,
at least a first air seal for at least partially sealing the first air passage,
at least a first lubricant seal for sealing the first air seal from a lubricant,
wherein the first air seal is arranged at a first seal carrier and the first lubricant seal is arranged at a second seal carrier, wherein the first seal carrier and the second seal carrier are non-integrally formed.

2. The rotary joint assembly of claim 1, further comprising a second lubricant seal, wherein the first air seal is axially positioned in between the first and second lubricant seals.

3. The rotary joint assembly of claim 2, wherein the second lubricant seal is arranged at a third seal carrier that is non-integrally formed with the first and second seal carriers and wherein the first seal carrier is axially positioned in between the second and third seal carriers.

4. The rotary joint assembly of claim 1, further comprising a second air seal that is arranged at the first seal carrier, wherein the first and second air seals and are axially spaced apart from one another.

5. The rotary joint assembly of claim 1, wherein the first air passage is located axially in between the first air seal and the first lubricant seal.

6. The rotary joint assembly of claim 1, wherein the first air passage extends outside of the first seal carrier.

7. The rotary joint assembly of claim 1, wherein the first air passage extends through the first seal carrier.

8. The rotary joint assembly of claim 1, further comprising a bushing that is arranged radially opposite to the first seal carrier and/or to the second seal carrier.

9. The rotary joint assembly of claim 8, wherein the bushing is in contact with the first air seal and/or the first lubricant seal.

10. The rotary joint assembly of claim 8, further comprising at least one sealing member disposed on a side of the bushing facing away from the first air seal and/or from the first lubricant seal.

11. The rotary joint assembly of claim 10, wherein the at least one sealing member comprises a sealing ring received in a recess formed in the bushing or in the second vehicle component.

12. The rotary joint assembly of claim 8, wherein the first air passage extends through the bushing.

13. The rotary joint assembly of claim 1, wherein the first seal carrier is configured to form an engagement with one of the first and second vehicle component to secure an axial position of the first seal carrier.

14. The rotary joint assembly of claim 13, wherein the first seal carrier comprises a circlip or another elastically deformable member to form the engagement.

15. The rotary joint assembly of claim 14, wherein the circlip or the other elastically deformable member is held in a recess in the first seal carrier.

16. The rotary joint assembly of claim 14, wherein the circlip or the other elastically deformable member is radially compressible.

17. The rotary joint assembly of claim 13, wherein a recess is formed in the first seal carrier or in the respective one of the first and second vehicle component and a protrusion is formed in the respective other one of the first seal carrier and the respective one of the first and second vehicle component, and wherein the recess and protrusion are configured to form the engagement.

18. The rotary joint assembly according to claim 7, wherein the first seal carrier is configured to from an engagement in two different regions, wherein the first air passage is located axially in between the different regions.

19. The rotary joint assembly of claim 1, further comprising a second air passage, wherein the first air passage and the second air passage are configured to be operated at different air pressures, wherein the first and second air passages are configured to be fluidically connected to different pressurized air sources or to different tires of the vehicle.

20. An assembly for providing a tire inflation system in a vehicle, the assembly comprising the rotary joint assembly of claim 1, the first vehicle component, and the second vehicle component.
